(19) United States
(12) Patent Application Publication
(10) Pub. No.: US 2017/0194806 A1
(43) Pub. Date: Jul. 6, 2017

(54) Portable Power Station Unit With Two Way Universal Serial BUS

(71) Applicant: Mathew Inskeep, Highland Beach, FL (US)

(72) Inventor: Mathew Inskeep, Highland Beach, FL (US)

(21) Appl. No.: 15/349,324

(22) Filed: Nov. 11, 2016

Related U.S. Application Data
(60) Provisional application No. 62/238,865, filed on Oct. 8, 2015.

(51) Int. Cl. H02J 7/00; H01R 24/64

(52) U.S. Cl. CPC H02J 7/0068; H02J 7/007; H01R 24/64; H01R 2107/00

(57) ABSTRACT

A rechargeable portable power station with two-way universal serial bus (USB) capable of recharging electronic devices as well as recharging itself. A bidirectional universal serial bus (USB) adapter port that can be integrated into a rechargeable portable power station. The invention can utilize a micro-controller to convert a single USB adapter port into either an input device or an output device. A power station with a bidirectional USB adapter port is capable of recharging external electronic devices, as well as recharging its own internal battery, through the same port. Due to the size of the internal battery of the power station, when used as an output device, the bidirectional USB adapter port will be able to provide many hours of operation before exhausting the power station's internal energy.

### CROSS REFERENCE TO RELATED APPLICATIONS

This application claims priority to U.S. Provisional Application Ser. No. 62/238,865, filed on Oct. 8, 2015, the disclosure of which is incorporated herein by reference in its entirety.

### STATEMENT REGARDING FEDERALLY SPONSORED RESEARCH

The Invention was not made under government contract nor was funded grant money used to fund the research.

### BACKGROUND OF THE INVENTION

The present invention is a rechargeable portable power station with integrated portable power capabilities via two-way universal serial bus (USB). Power stations are useful rechargeable portable battery powered devices that are comprised of several features which are designed for a particular purpose. In general the features of a power station provide users with power in the event of power outages, during nighttime outdoor activities, or to revive a dead vehicle electrical system. Additionally, power stations provide power to recharge electronic devices such as smart phones, tablets and lap top computers.

With our increased reliance on smart phones, tablet style computers and related portable devices, backup power is essential when away from a primary charging source such as a home outlet or automobile. Due to the demand for higher power, versatile design, and higher efficiency, the invention integrates a USB receptacle as a feature to the power station. The present invention, with its USB with the assistance of an adapter, is capable of powering and transferring energy to rechargeable electronic devices. Additionally, unlike traditional USB receptacles that provide output power only, this particular invention uses the same USB to draw energy from an external adapter to recharge Its own internal battery. Most other traditional devices require two separate receptacles In order to accomplish what this invention can achieve in a single receptacle. The invention utilizes USB adapters and modifies their electrical characteristics to allow the adapter to serve the two purposes of both powering and transferring energy to electronics or recharging itself through the same port.

Moreover, other devices that utilize a two-way USB receptacle are limited by design to their internal energy source, which only provides temporary energy. Applying a two-way USB receptacle in a power station, however, has greater Benefits. A power station is capable of providing greater energy levels at one time due to the size of the internal accumulator (battery). Integrating a two-way USB receptacle will provide many hours of operation before exhausting the power station's internal energy. Additionally, USB receptacles are capable of providing a high energy recharging option for faster and shorter recharging times, unlike conventional home chargers which only provide limited energy. A power station with a two-way USB is capable of accepting a charge via USB, and when coupled with a boost converter, can provide charge to its internal accumulator (battery) when recharging is needed. A power station with a two-way USB will provide maximum functionality to this feature and optimize its usage.

### BRIEF SUMMARY OF THE INVENTION

Disclosed is a rechargeable portable power station with integrated portable power capabilities via a two-way universal serial bus (USB). The two-way USB allows the power station to recharge external electronic devices and its own internal battery through the single port by utilizing a micro-controller to convert it Into either an input device or an output device. Thus, the invention provides the utilities of a traditional power station with the benefit of on the go backup power.

### BRIEF DESCRIPTION OF DRAWINGS

FIG. 1 is a block diagram of the internal functions of the universal serial bus (USB) control circuit.

FIG. 2 is a physical appearance of various universal serial ports available that can be used in combination with the power station.

### DETAILED DESCRIPTION OF THE INVENTION

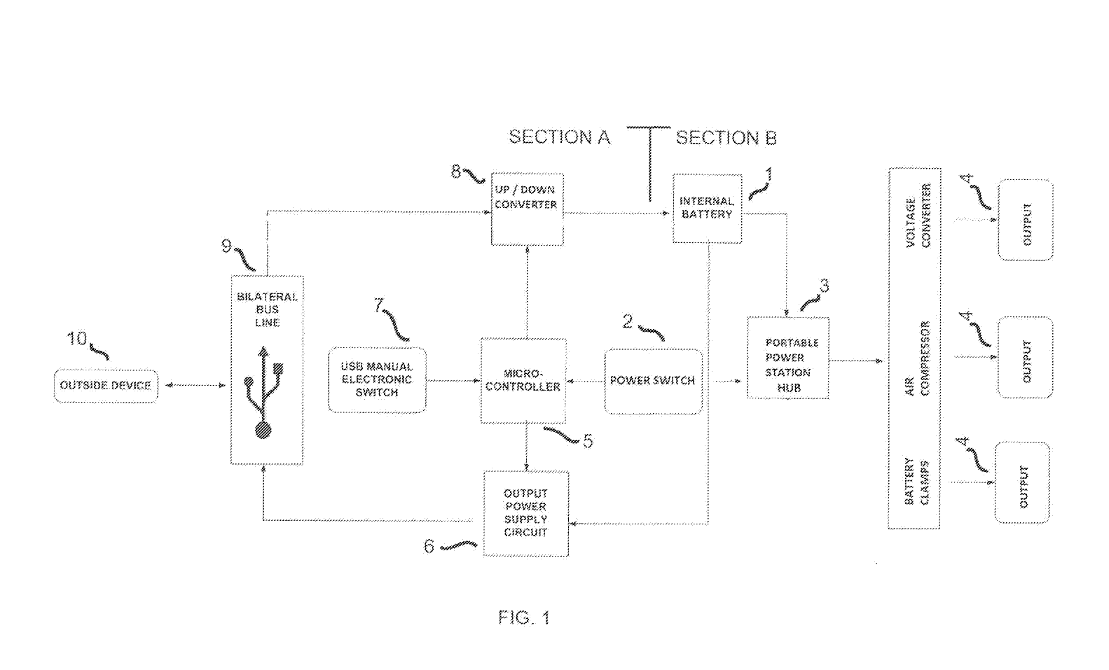

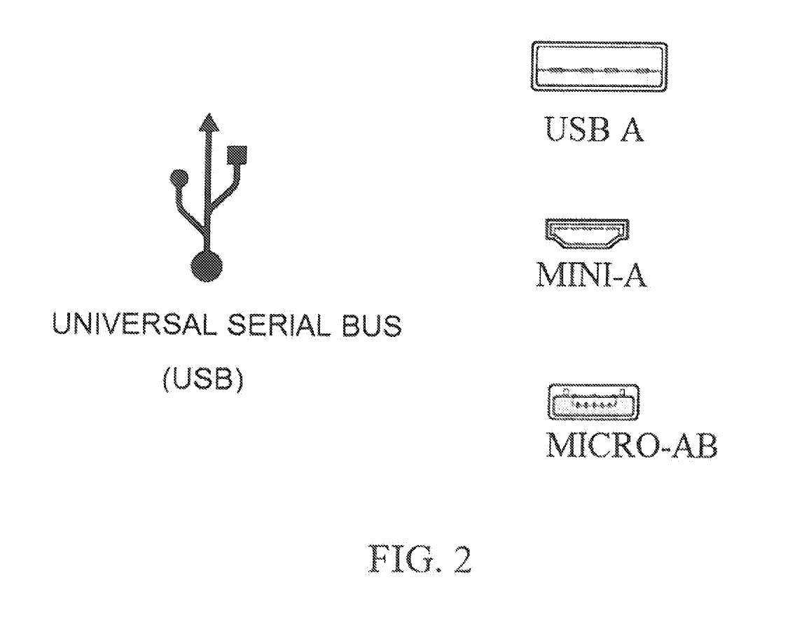

FIG. 1 shows an internal diagram of the present invention and all its major electrical components. The circuitry is divided into section A and section B. Section A describes the major components and internal circuits of the bidirectional universal serial bus (USB) 9 circuit operation. FIG. 1 is shown with one bidirectional USB 9; however, in other embodiments of the invention, there may be two or more bidirectional USB ports. Section B shows the operation of the portable power station, The combination of both circuits are essential to the invention. The USB adapter port 9 can be optimized for different situations. For example, the charging port's physical size and power carrying capabilities need not be limited to only one type of adapter. It can be optimized to allow high efficiency power across various situations. It may take other form as shown in FIG. 2; USB A, Mini A, Micro AB. Also, this particular adapter port's 9 main characteristic is to be mechanically and electrically coupled with any external device 10 with similar connectivity. The external device 10 can be directly coupled to the USB adapter port 9 or through an adapter USB extension cord.

In Section B of FIG. 1, the portable power station Is controlled when the power station switch 2 sends a signal to the micro-controller 5 to tell it that the power mode is active and therefore disables all other features. In this scenario, the circuitry converts the USB adapter 9 into an input device where current is drawn from an external adapter to recharge the internal battery 1 of the portable power station to power the output port, which is in the form of one of various features that can be included In the power station, such as battery clamps, air compressor or voltage converter. The micro-controller 5 processes this information and allows the current to flow from the USB adapter port 9, to the charging circuit 8, to the internal battery 1, to the portable power station and finally into the output port 4. The charging circuit 8 is a switching regulator. Its primary function is to limit the current and voltage potential to the internal battery 1 received from the USB adapter port 9 to typically five volts of direct current as per industry standard. Moreover, the portable power station 3 regulates the amount of current provided to the output port 4.

Section A describes the secondary function of the universal serial bus (USB) 9 which is to output and transfer energy from the internal battery 1 into rechargeable electronic devices such as mobile phones, digital cameras, mp3 and similar consumer products. This mode is activated when the user selects to use the USB manual electronic switch 7. The electronic switch 7 sends a signal to the micro-controller 5 indicating to toggle to the secondary function and turn the USB adapter port 9 into a power sourcing device. Sourcing device means that the energy transfer will now flow from the Internal battery 1 out to the external device 10. The way we accomplish this function Is to have the micro-controller 5, send a signal to the output power supply circuit 6 to activate and transfer the energy from the internal battery 1 into the USB adapter port 9. The power supply circuit 6 is a buck regulator that lowers the higher potential voltage from the battery typically above seven volt of direct current down to five volt of direct current which is the industry standard output voltage of a USB adopter port 9. This power supply circuit 6, allows control of the maximum current deliver to the external device 10.

1. A rechargeable power source device comprising a housing, at least one single electrical port that is a bidirectional universal serial bus (USB) adapter accessible through the housing and being connected to an internal battery, and an output port, wherein the internal battery can be charged via the bidirectional USB adapter for providing current to the output port or to an external rechargeable device.

2. The rechargeable power source device according to claim 1, wherein the internal battery is configured to provide energy to the output port and to the external rechargeable device.

3. The rechargeable power source device according to claim 1, wherein the output port is a function of the portable power station.

4. The rechargeable power source device according to claim 1, wherein a micro-controller is programmed to allow energy from an external source to enter through the single electrical port and recharge the internal battery and to allow energy from the internal battery to exit through the single electrical port to provide energy to an external electrical device.

5. The rechargeable power source device according to claim 1, wherein the single electrical port is a USB A port a MINI-A port, a MINI-B port, a MICRO-AB port or a MICRO-B port.

6. The rechargeable power source device according to claim 1, wherein the single electrical port has input and output energy transfer functionalities.

7. The rechargeable power source device according to claim 1, wherein the single electrical port is a universal serial bus adapter port with bidirectional capabilities with input and output energy transfer functionalities.

8. The rechargeable power source device according to claim 1, wherein microcontroller is programmed to allow either the recharging of the internal battery or the powering of the external electrical device at a specific instant in time and not both at the same time.

9. The rechargeable power source device according to claim 1, wherein the single electrical port is a two-way port and acts as an input device when recharging the internal battery and the sets as an output device when the internal battery is providing power for the external second electrical device.

10. The rechargeable power source device according to claim 1, wherein a microcontroller is provided for controlling the transfer of energy from the internal battery into the bidirectional USB adapter or to the output port.

11. The rechargeable power source device according to claim 1, wherein a battery charging circuit is provided for limiting the current and voltage potential to the internal battery received from the USB adapter.

12. The rechargeable power source device according to claim 1, wherein the amount of voltage potential is about 5 volts.

13. The rechargeable power source device according to claim 1, wherein the portable power station regulates the amount of current provided to the output port.

14. The rechargeable power source device according to claim 1, wherein the device further comprises a USB manual electronic switch being configured to send a signal to the micro-controller to toggle to a secondary function and turn the USB adapter into a power sourcing device.

15. The rechargeable power source device according to claim 1, wherein the power sourcing device transfers the energy from the external battery out to the external device.

16. The rechargeable power source device according to claim 1, wherein an output power supply circuit is provided to activate and transfer the energy from the internal battery into the USB adapter.

17. The rechargeable power source device according to claim 1, wherein the output power supply circuit is a buck regulator capable of lowering a higher potential voltage from the internal battery from a voltage of about 7 volts of direct current down to 5 volts current.

18. The rechargeable power source device according to claim 1, wherein the output power supply circuit is a boost regulator capable of increasing a lower potential voltage from the internal battery from a voltage of about 5 volts of direct current up to 7 or more volts current.

19. The rechargeable power source device according to claim 1, wherein the output power supply circuit allows control of a maximum current delivered to the external device.

20. The rechargeable power source device according to claim 1, wherein the power source is a portable power station.

21. The rechargeable power source device according to claim 1, further comprising a battery charging circuit in communication with the internal battery and in communication with the USB port, the battery charging circuit disposed within the housing, the battery charging circuit also in communication with the microcontroller.

22. The rechargeable power source device according to claim 1, further comprising an output power supply circuit in communication with the microcontroller and with the internal battery, the output power supply circuit disposed within the housing.

23. The rechargeable power source device according to claim 1, wherein the external electrical device is adapted for electrical or mechanical coupling to the USB port directly or indirectly through a cord.
